(19) United States
(12) Patent Application Publication
(10) Pub. No.: US 2011/0300362 A1
(43) Pub. Date: Dec. 8, 2011

(54) Fire Insulation Material

(75) Inventors: Brian James, Essex (GB); Mark Newton, Essex (GB)

(73) Assignee: FIRESPRAY INTERNATIONAL LIMITED, Harlow, Essex (GB)

(21) Appl. No.: 13/119,139

(22) PCT Filed: Sep. 15, 2009
(86) PCT No.: PCT/GB09/51191

§ 371 Date: Jun. 6, 2011

(30) Foreign Application Priority Data
Sep. 15, 2008 (GB) 0816818.9

(51) Int. Cl. B32B 5/02; B32B 18/00; B32B 15/04; B06B 1/00

(52) U.S. Cl. 428/220; 427/600; 428/379; 442/136; 428/221

(57) ABSTRACT

A process for the production of a fire insulation material, the process comprising the steps of vibration of a decomposable substance into alkali earth silicate fibres to form the insulation material; a fire insulation material obtainable by the above process, suitably in the form of a mat; a fire insulation material comprising alkali earth silicate fibres and a decomposable substance.

### FIELD

The present invention relates to a fire insulation material and a process for making a fire insulation material.

### BACKGROUND

The purpose of a fire insulation material is to shield an area that is required to be insulated from a fire and to ensure that the temperature on the surface of the fire insulation, which could be a fire door, fire partition or fire-insulated duct, does not exceed 140° C. plus ambient temperature in an area adjacent to the fire. In fires, it is not uncommon for temperatures in excess of 1100° C. to be reached. Therefore a considerable amount of heat needs to be absorbed by the fire insulation.

Mineral wool is commonly used as an insulating or flame retardant material in fire insulations. In the case of ducting, the mineral wool is wrapped around a duct that requires insulation and in the case of fire doors or partition walls, the wool is formed as a fire resistant core inside the door or wall to be protected.

Whilst mineral wool has proven to be an effective insulator, it has been found that a considerable volume of mineral wool is required before satisfactory fireproofing can be achieved. In the UK, for example, in order to achieve a 2 hour insulation rating to the requirements of BS476 Part 24, it is necessary to insulate the duct with 160 kg/m³ mineral wool, approximately 100 mm thick.

The requirement of a large volume of mineral wool results in the fire insulation taking up a considerable amount of space and can add a substantial amount of weight. In addition, it is costly to provide a large volume of mineral wool.

An alternative to mineral wool as an insulating or flame retardant material is calcium silicate board. Whilst this material is an efficient fire insulant, it is not flexible, quite fragile and absorbs moisture.

The use of decomposable materials such as aluminium hydroxide, which decompose to release water on heating, are known in the part art, for example, as disclosed in WO2006097721.

### SUMMARY

Disclosed herein is a process for the production of a fire insulation material, the process comprising the steps of vibration of a decomposable substance into alkali earth silicate fibres to form the insulation material, and to a fire insulation material obtainable by the above process, suitably in the form of a mat.

A further aspect relates to a fire insulation material obtainable by the above process additionally comprising an outer coating of foil on at least one face, and suitably encasing the insulation material.

A further aspect relates to a fire insulation material comprising alkali earth silicate fibres and a decomposable substance, optionally additionally comprising an outer coating of foil on at least one face, and suitably encasing the insulation material.

A further aspect relates to an article comprising a fire insulation material, the fire insulation material comprising alkali earth silicate fibres and a decomposable substance, and to an article comprising a fire insulation material obtainable by vibration of a decomposable substance into alkali earth silicate fibres.

### GENERAL DESCRIPTION

The present disclosure generally relates to the production of a fire insulation material comprising a combination of a fibrous substrate and a decomposable substance, and to a fire insulation material comprising alkali earth silicate fibres and a decomposable substance.

Suitable fibres are alkali earth silicate fibres such as calcium or magnesium silicates, or calcium magnesium silicates such as amorphous calcium magnesium silicates. Calcium magnesium silicate fibre is also commonly referred to as synthetic vitreous fibre (SVF), man-made vitreous fibre (MMVF), and man-made mineral fibre (MMMF).

In one aspect the fibre is an amorphous calcium magnesium silicate having a composition of, expressed as a % by weight:

### SO₂—60 to 70%

### CaO—27 to 33%

### MgO—2 to 7%

### Other <1%

In another aspect the fibre is an amorphous calcium magnesium silicate having a composition defined by its CAS No. 436083-99-7 of, expressed as a % by weight:

| | |
|---|---|
| Silica (SiO₂) | 50-82% |
| Calcia (CaO) and Magnesia (MgO) | 18-43% |
| Alumina (Al₂O₃), Titania (TiO₂) and Zirconia (ZrO) | <6% |

(Plus trace oxides).

In one aspect the fibre has a diameter of 0.1-12 microns, such as 0.5-3 microns or 3-5 microns.

In one aspect the melting point of the fibres is greater than 1000° Celsius, such as greater than 1100° Celsius, greater than 1200° Celsius or greater than 1300° Celsius.

The loose density of the fibres may be between 0.5-5 g/cm³.

In one aspect the fibres are formed into a mat, generally rectangular, before addition of the decomposable substance. In some embodiments the fibre mats may be between 5-50 mm in thickness, such as 10-45 mm, such as 20-35 mm, for example 13, 19, 25, 30, 35, 38 and 50 mm. In one aspect the mats may have densities of between 30-120 kg/m³, such as 50-100 kg/m³, such as 64 kg/m³ or 96 kg/m³.

In one aspect the mat for use in the process of the invention may be a 25 mm thick mat with 64 kg/m³ density, comprising fibres having a diameter of 3-5 microns and a composition of (% by weight):

### SiO₂—60 to 70%

### CaO—27 to 33%

### MgO—2 to 7%

### Other <1%

One commercial mat that may be used is the Unifrax Insulfrax blanket, CAS number 436083-99-7. Another commercial mat that may be used is the Unifrax Fyrewrap blanket.

The fibres or mat are vibrated as described herein with a decomposable substance, to deliver the decomposable substance into the fibres or mat.

In one aspect the decomposable substance comprises molecules which are chemically and physically stable at ambient temperatures and which generate an endothermic reaction during a temperature rise.

In one aspect the decomposable substance may be a material that decomposes when heated to release water. Water as the fluid produced on decomposition is advantageous because it is non-toxic and has a high specific heat capacity and high heat of vaporization.

In one aspect the decomposable substance is primarily composed of aluminium hydroxide and/or magnesium hydroxide. In one aspect the decomposable substance is primarily composed of aluminium hydroxide or magnesium hydroxide.

In one aspect the particles of decomposable substance have a d50 between 15.0-25.0 microns. The d50 is the median diameter. For a sample, if d50=5 micron, there are 50% particles larger than 5 micron, 50% smaller than 5 micron.

Where aluminium hydroxide is used, then the aluminium hydroxide may be MARTINAL® ON-320, for example, commercially available from Albemarle Corporation, and having a composition as follows [CAS number 21645-51-2]

| | |
|---|---|
| Al(OH)₃, %, approx. | 99.6 |
| Moisture (105° C.), % | 0.2 |
| Loss on ignition (1200° C.), %, approx. | 34.5 |
| Na₂O (soluble), % | 0.03 |
| Particle size (laser diffraction, Cilas) | |
| d10 μm | 2.5-4.5 |
| d50 μm | 15.0-25.0 |
| d90 μm | 40.0-70.0 |
| Solubility in water (20° C., pH 7), g/l | 1.5 × 103 |
| Refractive index | 1.58 |
| Electrical conductivity (10% in H₂O), kg/m³ | 120 |
| Whiteness (Elrepho 457 nm), %, approx. | 90 |
| Oil absorption, cm³/100 g | 20-25 |
| DOP absorption, cm³/100 g | 25-32 |
| Density, g/cm³ | 2.4 |
| Bulk density, kg/m³, approx. | 900 |

Where magnesium hydroxide is used then this may be, for example, Magnafin H5, available from Albemarle Corporation. It has a particle size as follows:

d10 [μm] 0.70-1.00
d50 [μm] 1.60-2.00
d90 [μm] 2.40-4.40

The decomposable substance is in a dry form when applied to the fibres.

In one aspect the decomposable substance is loaded onto the fibres or fibre mat at a final amount of between 2-5 kg/m² of fibres, suitably at 2-4 kg/m², with 4 kg/m² being preferred. Suitably this final amount of decomposable substance is for a mat of 64 kg/m³ density.

The decomposable material is in one aspect impregnated into the mat by vibration. Any suitable vibration means may be used to impregnate material into the fibres.

In one aspect the vibration is provided by a rotary pneumatic turbine vibrator.

In one aspect the GT vibrators, such as the GT25 modules from Vibratechniques Ltd (www.vibtec.com) may be used to provide suitable vibration, which is produced by the centrifugal force of the positive and negative unbalanced moments in the rotor.

In one aspect the vibration system used is a pneumatic vibration bed, and may use turbine vibrators, in one aspect cresting 10-20,000 vibrations per minute, such as 12-17, 000 vibrations per minute, and in one aspect at an amplitude of 1-5 mm, such as 2-3 mm.

In one aspect each section of insulation fibre is vibrated for approximately 1-5 minutes, such as 2-3 minutes. This is generally suitable for loading 4 kg/m² of powder added onto 64 kg/m³ insulation as described herein.

Following vibration the decomposable material is suitably distributed evenly through the fibres or mat of fibres.

A further aspect relates to a fire insulation material obtainable by vibration as disclosed above, suitably in the form of a mat.

According to a further aspect there is provided a fire insulation product comprising at least two layers of fire insulation material as described above. The separate layers in a fire insulation product may be separated by a layer of another material, such as aluminium foil. The layer of another material between adjacent layers of fire insulation may be sacrificial; aluminium foil may be used as the sacrificial layer.

In further aspects the fire insulation material of the invention, once produced by the method of the invention, may have an outer cover, for example be covered with an aluminium foil, such as H & V foil (Heating and Ventilation foil), also BCO foil (Bright Class O foil), or plain foil, such as 50 micron aluminium foil. The foil may be on at least one face of a fibre mat, for example. In another aspect the foil wholly or partially encases the fibres or mat, in which case the foil suitably is wrapped over the majority or all of the exposed surface area of the fibres or mat.

In one aspect the foil has an eglass scrim on one side, which makes it much more durable than standard aluminium foil of the same thickness.

In one additional aspect the H&V foil, or any another suitable foil, is sealed to itself around the fire insulation material with the use of heat sealing.

In one aspect two or more layers of the fire insulation of the present invention are used together, and two, or more, of the layers are wrapped in foil, such as aluminium foil. This provides a synergistic effect on the fire protection properties, with the use of a double layer of the fire insulation of the invention, for example, resulting in greater than twice the level of insulation of a single layer of comparable material. Without wishing to be constrained by theory it is thought that the first layer of insulation proximal to the heat source generates a vapour via the decomposition of the decomposable material, for example forming steam, which acts to insulate the second layer, delaying the heating of this layer, and increasing the fire protection profile.

Thus in a further aspect the disclosure relates to an article comprising a mat of the fire insulation material of the present invention wrapped in foil, such as aluminium foil, directly adjacent another mat of any other fire resistant material. Suitably the mat wrapped in foil is adjacent another fire insulation material mat of the present invention, suitably another fire insulation material mat of the present invention which is also wrapped in foil.

A further aspect relates to a fire insulation product comprising 2, or more, mats of fire insulation material of the present invention, the mats being affixed to one another and each mat being wrapped in foil, such as aluminium foil.

In one aspect the fire insulation product is flexible, and can suitably can be readily folded and/or rolled.

In one detailed aspect the present disclosure relates to a flexible fire insulation product comprising calcium magnesium silicate fibres in the form of a mat 5-50 mm in thickness, having a density of 30-120 kg/m³ and a loading of 4 kg/m² aluminium hydroxide and/or magnesium hydroxide, in one aspect being produced by vibration of the aluminium hydroxide and/or magnesium hydroxide into the mat.

Suitably the fire insulation product is able to achieve at least 1 hour performance in accordance with EN1366, ISO 6944 and ASTM 2336 standards, and in further aspects can achieve at least 90 minutes, at least 120 minutes, at least 150 minutes, at least 180 minutes or more.

In a further aspect there is provided an article containing a fire insulation material according to the present disclosure; such as a fire door containing a fire insulation material according to the present disclosure; ductwork installation containing a fire insulation material according to the present disclosure; a partition wall containing a fire insulation material according to the disclosure; a prefabricated building unit for a building containing a fire insulation material according to the present disclosure; and a bulkhead for a ship containing a fire insulation material according to the present disclosure.

The fire insulation material of the present disclosure may be used in ventilation, pressurization, kitchen & smoke extraction ducts.

All references cited herein are incorporated fully by reference.

Any reference to an embodiment or an aspect of the invention may be combinable with any other embodiment or aspect of the invention.

Any reference to products ‘obtainable’ by a process herein also includes products obtained by that process.

The present disclosure is illustrated according to the following example, which is not limiting upon the present invention:

### EXAMPLES

Testing was carried out using a pneumatic vibration bed, using turbine vibrators, cresting 12-17,000 vibrations per minute, at an amplitude of 2-3 mm, using GT25 modules as described above. 6 GT25 modules were used, each with a 300 mm square plate above, to provide an area approx 600 mm×900 mm.

Testing was carried out on a variety of materials to achieve test standards EN1366, ISO 6944 and ASTM 2336, (European, International and American standards).

Testing was initially carried out with insulation on a plate across a furnace front before carrying out full duct tests

In all cases each mat of the fire insulation material was wrapped in one layer of aluminium foil, surrounding the faces of the mat.

### Plate Tests

Two plate tests using the principals of the Lloyds A60 standard for Aluminium bulkheads (1 hour insulation requirement) was carried out, to produce insulation failure times on insulation material on a 1-meter square aluminium panel across the face of a furnace.

The furnace temperature was controlled to match a standard cellulosic time/temperature curve, and the temperatures on the outside of the furnace through the insulation was measured with 5 thermocouples; one located at the centre of the insulated panel, and the other 4 located at the corners of the panel, 250 mm from the edge of the panel.

The initial Lloyds panel with insulation (a single 25 mm 96 kg/m³ layer impregnated with 2 kg/m² aluminium hydroxide, and wrapped with foil) on the fireside, and thermocouples reading the temperature on the 5 mm thick aluminium panel recorded a failure at 76 minutes.

The failure time of the insulation is recorded when one of the thermocouples reach 180° C. (plus initial ambient temperature), or the average of all 5 thermocouples reaches 140° C. (plus initial ambient temperature) during the test.

A further Lloyds panel was tested with the same insulation on both sides of the panel, with thermocouples on the non-furnace side of the 5 mm aluminium plate underneath the outer layer of insulation, with a failure criteria of 200° C. plus ambient, this test also failed at 76 minutes.

These tests compare favourably with plain 50 mm 96 Kg material used, which achieved 81 and 70 minutes respectively. The present 25 mm material provides the same fire resistant properties as the 50 mm material of the prior art, with concomitant advantages in that it occupies less space, which is advantageous in bulkheads, for example.

### Duct Tests

A 1500 mm long duct was tested to the principal of EN1366 fire inside duct testing, with a duct subjected to internal temperatures in accordance with EN1366 cellulosic time/temperature curve (ISO 834 time/temperature curve), and the duct wrapped with insulation. A total of 8 thermocouples were used; the first set of four are located 25 mm from the penetration of the ducting from the furnace front, and another set of four located 300 mm from the initial set. In each set the thermocouples are located centrally on each face of the insulated ductwork. The failure time of the insulation is recorded when one of the thermocouples reach 180° C. (plus initial ambient temperature), or the average of all 4 thermocouples at 325 mm reaches 140° C. (plus initial ambient temperature) during the test.

A number of duct tests were carried out with 2 layers of 25 mm 64 kg material with 4 kg/m² of aluminium hydroxide. These generally gave results in excess of 2 hours insulation, such as 2 hours 20 minutes, before failure. Under BS EN1366-1 test conditions, this product achieved over 2 hours insulation, as required by the standard.

A further duct test was carried out with 2 layers of 30 mm insulation, again loaded with 4 kg/m² of aluminium hydroxide for comparison, but did not show any improvement over the 25 mm system, which showed that the majority of improvement in performance was from the impregnated material, with the insulation acting as a general background insulation.

### Comparative Tests

By way of comparison, the only current standard for 2 hours insulation from the manufacturer of a calcium magnesium silicate insulation mat is to use 3 layers of 50 mm 96 kg, which when tested failed at 2 hours 26 minutes.

1. A process for the production of a fire insulation material, the process comprising the steps of vibrating a decomposable substance into alkali earth silicate fibres.

2. A process according to claim 1 wherein the fibres are at least one calcium, magnesium silicates, or calcium magnesium silicates.

3. A process according to claim 1 wherein the fibres have a fibre diameter of 0.1-12 microns.

4. A process according to claim 1 wherein a melting point of the fibres is greater than 1000° Celsius.

5. A process according to claim 1 wherein the fibres are preformed into a mat before addition of the decomposable substance.

6. A process according to claim 5 wherein the fibre mats are between 5-50 mm in thickness.

7. A process according to claim 5 wherein the fibre mats have densities of between 30-120 kg/m³.

8. A process according to claim 1 wherein the decomposable substance comprises at least one of aluminum hydroxide or magnesium hydroxide.

9. A process according to claim 1 wherein the decomposable substance is in a powder form or a particle form when applied to the fibres.

10. A process according to claim 1 wherein the vibrating is provided by a rotary pneumatic turbine vibrator.

11. A process according to claim 10 wherein the rotary pneumatic turbine vibrator operates at between 10-20,-000 vibrations per minute at an amplitude 2-3 mm.

12. A process according to claim 1 further comprising coating the fire insulation material with aluminum foil on a least one face after the decomposable material has been vibrated into the fibres.

13. A process according to claim 1 wherein the resulting fire insulation product is flexible, and can be at least one folded or rolled.

14. A fire insulation material obtainable by the process of claim 1.

15. A fire insulation material comprising alkali earth silicate fibres and a decomposable substance.

16. A material according to claim 15 wherein the fibres are at least one of calcium, magnesium silicates, or calcium magnesium silicates.

17. A material according to claim 15 wherein the fibres have a fibre diameter of 0.1-12 microns.

18. A material according to claim 15 wherein a melting point of the fibres is greater than 1000° Celsius.

19. A material according to claim 15 wherein the fibres are preformed into a mat before addition of the decomposable substance.

20. A material according to claim 19 wherein the fibre mats are between 5-50 mm in thickness.

21. A material according to claim 19 wherein the fibre mats have densities of between 30-120 kg/m³.

22. A material according to claim 15 wherein the decomposable substance comprises at least one of aluminum hydroxide or magnesium hydroxide.

23. A material according to claim 15 wherein the decomposable substance is in a powder form or a particle form when applied to the fibres.

24. A material according to claim 15 wherein the fire insulation material is coated with aluminum foil on at least one face.

25. A material according to claim 15 wherein the fire insulation product is flexible and can be at least one of folded or rolled.

26. A fire insulation material according to claim 15 capable of in excess of 2 hours insulation when tested to the principal of EN1366 fire inside duct testing.

27. (canceled)
